(19) United States
(12) Patent Application Publication
(10) Pub. No.: US 2014/0326781 A1
(43) Pub. Date: Nov. 6, 2014

(54) Linear Friction Welding Method

(71) Applicant: APCI, LLC, South Bend, IN (US)

(72) Inventor: Stephen A. Johnson, South Bend, IN (US)

(21) Appl. No.: 14/359,279

(22) PCT Filed: Dec. 5, 2012
(86) PCT No.: PCT/US12/67840

§ 371 Date: May 19, 2014

Related U.S. Application Data
(60) Provisional application No. 61/630,130, filed on Dec. 5, 2011.

(51) Int. Cl. B23K 20/12

(52) U.S. Cl. CPC B23K 20/1205
USPC 228/112.1; 228/2.1

(57) ABSTRACT

A linear friction welding method and linear friction welding apparatus for joining two work pieces. The method involves vibrating a third weld component, or “coupon” between the two principle work pieces under a welding pressure. Friction between the coupon and work pieces causes the material at the weld surfaces to plasticize. Abruptly halting the vibration and pressing the work pieces against the coupon under a final load or forging pressure sets the weld interface.

This application claims the benefit of U.S. Provisional Patent Application, Ser. No. 61/630,130 filed Dec. 5, 2011, the entirety of which is incorporated by reference herein.

This invention relates to a method for bonding to two work pieces together using linear friction welding, and in particular bonding a third component between the two work pieces.

### BACKGROUND AND SUMMARY OF THE INVENTION

Linear friction welding (LFW) is a process of joining two components which may be made from the same or different materials. The LFW process typically involves pressing the two components together under a large amount of force and rapidly vibrating the components with respect to one another to generate friction at the interface between the two components. The pressure and movement generate sufficient heat to cause the material at the interface to plasticize. Once the material at the interface begins to plasticize, the vibration is stopped and an increased force is applied. As the plasticized material of both components cools in this static condition, the components are bonded together and a weld is formed. While LFW is suitable in many applications, heretofore, LFW has not been practical for repair welds.

The present invention provides a linear friction welding method and linear friction welding apparatus for joining two work pieces. The method involves vibrating a third weld component, or “coupon” between the two principle work pieces under a welding pressure. The vibration of the weld coupon is facilitated and controlled by a linear friction welding (LFW) machine, such as the ones available from APCI, Inc. of South Bend, Ind. Friction between the coupon and work pieces causes the material at the weld surfaces to plasticize. Abruptly halting the vibration and pressing the work pieces against the coupon under a final load or forging pressure sets the weld interface.

The apparatus and method of the present invention may take form in various systems and components, as well as the arrangement of those systems and components. The above described features and advantages, as well as others, will become more readily apparent to those of ordinary skill in the art by reference to the following detailed description and accompanying drawings. The drawings are only for purposes of illustrating exemplary embodiments and are not to be construed as limiting the invention.

### BRIEF DESCRIPTION OF THE DRAWINGS

The drawings illustrate the present invention, in which:

FIG. 1 is side view of the weld coupon positioned between two work pieces showing an initial step of the method of this invention using a linear friction welding machine;

FIG. 2 is a side view of the two work pieces being pressed against the weld coupon as the weld coupon is vibrated to form the weld interface using the method of this invention.

### DESCRIPTION OF THE PREFERRED EMBODIMENT

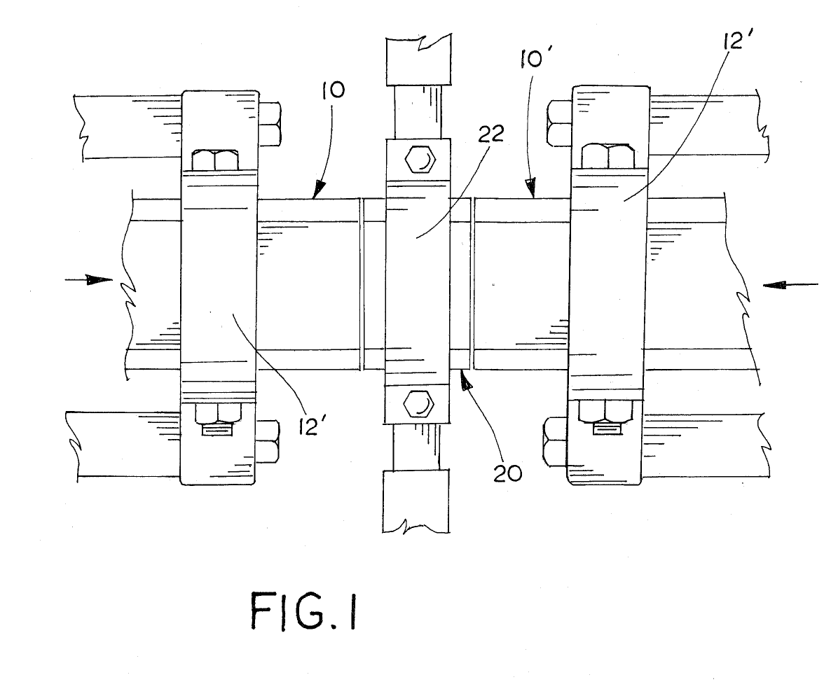

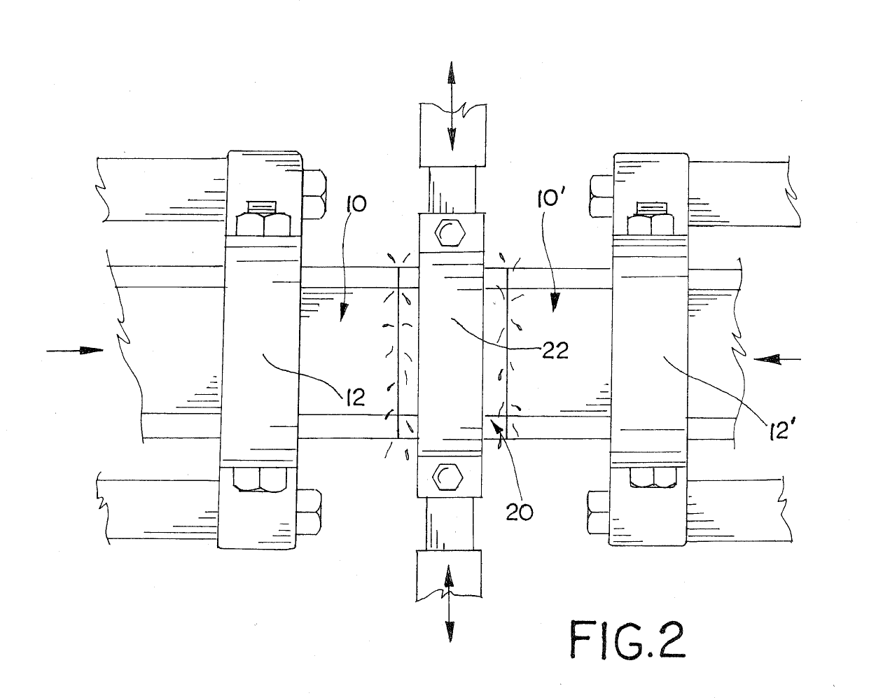

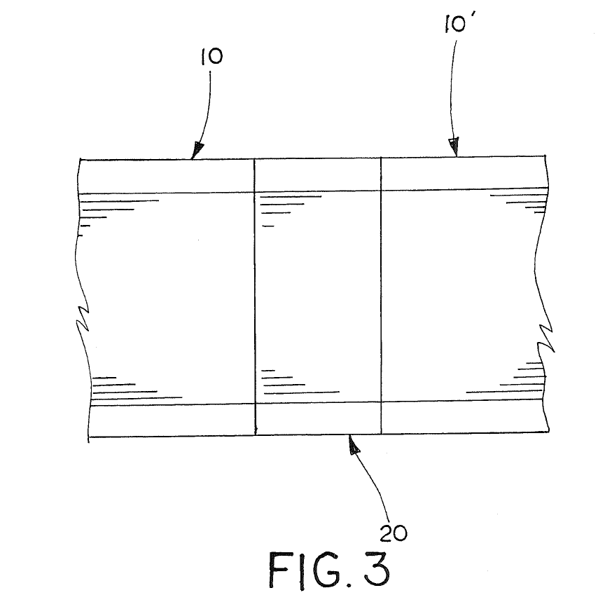

Referring now to the drawings, FIGS. 1-2 illustrate an embodiment of the method of this invention for welding two work pieces 10 and 10′ using a linear friction welding (LFW) machine (not shown). The LFW method of this invention is illustrated and explained hereinafter by way of example in the joining of two components end to end, although, those skilled in the art may readily adapt and apply the teaching of this invention to other applications. In addition, the linear friction welding (LFW) repair method of this invention can be used to join ferrous work pieces regardless of configuration or metal composition.

### LFW Machine & Fixtures

While the method of this invention may employ the use of any linear friction welding (LFW) equipment, machine or apparatus, the method is best employed using linear friction welding (LFW) linear friction welding (LFW) apparatus, fixtures and machines, such as the ones developed by APCI, Inc. in South Bend, Ind. and described in U.S. patent application Ser. No. 12/868,623 filed Aug. 25, 2010, which issued as U.S. Pat. No. 8,070,039 on Dec. 6, 2011. The LFW apparatus, fixtures and machines from APCI are ideal for the repair process of this invention because of their ability to control the amplitude, frequency and termination of the weld oscillation, as well as the weld and force pressures during the weld process. The teachings of the U.S. Pat. No. 8,070,039 are incorporated herein by reference. The LFW machine generally includes a pressing assembly, which provides the weld and forge pressure to the components being bonded and a vibrating assembly, which vibrates the components to generate friction between the components. For simplicity of illustration and explanation, the press assembly and the vibration assembly of the LFW machine are not shown.

The LFW repair method of this invention begins with providing a mating weld block or “weld coupon” 20. The weld coupon is generally cast, formed or machined from the same material as work pieces 10 and 10′ or a compatible material for bonding to the work pieces. Weld coupon 20 generally provides some new material to the bonded work piece assembly. Consequently, the thickness of coupon 20 is configured to provide the desired thickness for the particular weld application. In addition, weld coupon 20 is configured to have a corresponding shape and profile of that of the work pieces.

When the weld is formed, weld coupon 20 is held in a mounting fixture 22 and work pieces 10 and 10′ are held in mounting fixtures 12 and 12′ of the LFW machine. Coupon fixture 22 is operatively connected to vibration assembly 120 of the LFW machine. Work pieces 10 and 10′ are held in mounting fixtures 12 and 12′ respectively. At least one of fixtures 12 and 12′ are operatively connected to the press assembly of the LFW machine. Once the weld coupon 20 and both work pieces 10 and 10″ are properly seated and secured in the mounting fixtures of the LFW machine, the LFW machine vibrates coupon 20 while pressing work pieces 10 and 10′ axially together against the coupon under an initial load or “weld pressure” (FIGS. 5, 6 and 8). Friction caused by the vibration and the weld pressure causes the material at the weld surfaces to plasticize. The vibration is then abruptly stopped and work pieces 10 and 10′ are pressed together against weld coupon 20 under a final load or forging pressure, which forms the weld interface. Once the weld interface is formed, the joined work assembly can be removed from the LFW machine and further machined as necessary to finish the final component.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

1-2. (canceled)

3. A method of operably connecting two work pieces using linear friction welding, the method comprising:
securing a first work piece in a linear friction welding assembly;
aligning a second work piece with the first work piece along a press axis;
positioning an intermediate weld coupon between the first work piece and the second work piece such that the intermediate weld coupon is aligned with the first work piece and the second work piece along the press axis;
vibrating the intermediate weld coupon orthogonally to the press axis with the linear friction welding assembly while forcing the first work piece toward the second work piece with a first force;
stopping vibration of the intermediate weld coupon; and
forcing the first work piece toward the second work piece with a second force after the vibration of the intermediate weld coupon has been stopped.

4. The method of claim 3, wherein:
the first work piece has a first weld surface with a first profile orthogonal to the press axis;
the intermediate weld coupon has a second weld surface with a second profile orthogonal to the press axis;
the second weld surface is in direct opposition to the first weld surface when the intermediate weld coupon is aligned with the first work piece; and
the first profile corresponds to the second profile.

5. The method of claim 4, wherein:
the second work piece has a third weld surface with a third profile orthogonal to the press axis;
the intermediate weld coupon has a fourth weld surface with a fourth profile orthogonal to the press axis;
the fourth weld surface is in direct opposition to the third weld surface when the intermediate weld coupon is aligned with the second work piece; and
the third profile corresponds to the fourth profile.

6. The method of claim 5, wherein the fourth profile corresponds to the second profile.

7. The method of claim 3, wherein:
the first work piece comprises a first type material;
the intermediate weld coupon comprises a second type material; and
the first type material and the second type material are different types of material.

8. The method of claim 3, wherein:
the first work piece comprises a first type material;
the intermediate weld coupon comprises a second type material; and
the first type material and the second type material are the same type material.

9. The method of claim 3, wherein:
the second force is greater than the first force.

10. A linear friction welding system, comprising:
a press assembly defining a press axis;
a ram configured to vibrate along a welding axis, the welding axis orthogonal to the press axis;
a first fixture configured to hold a first work piece in fixed relationship to the press assembly;
a second fixture configured to hold a second work piece aligned with, and spaced apart from, the first work piece along the press axis; and
a third fixture configured to hold a third work piece in fixed relationship with the ram at a location between the first work piece and the second work piece.
